(19) United States
(12) Patent Application Publication
(10) Pub. No.: US 2006/0047064 A1
(43) Pub. Date: Mar. 2, 2006

(54) Coating agent for forming antifogging film and method for forming antifogging film using same

(76) Inventors: Noboru Murata, Mie (JP); Masahiro Hirukawa, Mie (JP); Hiroshi Honjo, Chiba (JP); Toshiro Matsuura, Mie (JP); Seiji Yamazaki, Mie (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/513,680

(22) PCT Filed: Jul. 29, 2003
(86) PCT No.: PCT/JP03/09564

§ 371 Date: Nov. 8, 2004

(30) Foreign Application Priority Data
Aug. 1, 2002 (JP) 2002224385
Aug. 7, 2002 (JP) 2002229446
Sep. 25, 2002 (JP) 2002278888
May 22, 2003 (JP) 2003144857
Jun. 18, 2003 (JP) 2003173053
Jul. 9, 2003 (JP) 2003272270

(51) Int. Cl. C08G 18/08

(52) U.S. Cl. 524/589

(57) ABSTRACT

The invention relates to a two-package coating agent for forming an antifogging film. This coating agent contains a first coating agent comprising an isocyanate containing an isocyanate group; and a second coating agent comprising (a) a polyol component comprising at least a water-absorbing polyol and a hydrophobic polyol and (b) a surfactant comprising a group that is reactive with the isocyanate group. It is possible to form an antifogging film by a method including the steps of mixing the first and second coating agents together to prepare a coating agent; applying the coating agent to the substrate to form a precursory film on the substrate; and hardening the precursory film under room temperature or heating into the antifogging film.

### BACKGROUND OF THE INVENTION

The present invention relates to a coating agent for forming antifogging films, an antifogging article having such antifogging film, and a method for forming antifogging films using the coating agent. The antifogging films can be used for antifogging mirrors for bathroom, washroom, etc., vehicular and architectural antifogging window glasses and mirrors, and other applications such as lens and display.

When water drops adhere to a transparent substrate (e.g., glass and plastic), for example, by an abrupt change of temperature and humidity, the light scatters by the water drops to generate a so-called “fogging”. With this, various transparent substrates (e.g., common window glasses, vehicular and aircraft front windshields, reflecting mirrors, spectacle lens, and sunglasses) are impaired in visibility and safety. Therefore, it is very effective to form an antifogging film on various transparent substrates to prevent fogging. For example, in the case of antifogging films of vehicular front windshields, the antifogging films are subjected by a wiper blade to a continuous wiping under certain pressure in rain occasion. Therefore, such antifogging films are required to have both antifogging property and wear resistance.

Japanese Patent Application Publication 60-85939, corresponding to U.S. Pat. No. 4,551,484, discloses a transparent, antifogging film comprised of a plastic material containing a surface active agent.

Japanese Patent Application Publication 61-502762, corresponding WO86/00916, discloses an antifogging coating composition comprising a polymer (e.g., polyvinylpyrrolidone), a polyisocyanate prepolymer, a surfactant, and an organic solvent.

Japanese Patent Application Publication 2000-515572, corresponding to U.S. Pat. No. 5,877,254, discloses an antifogging polyurethane composition containing an isocyanate prepolymer, a hydrophilic polyol, and an isocyanate-reactive surfactant.

In recent years, antifogging films have been required to have further improved wear resistance for a longer time and to have antifogging property even at under freezing point.

### SUMMARY OF THE INVENTION

It is therefore an object of the present invention to provide a coating agent for forming an antifogging film that is superior in antifogging property and wear resistance for a long time even at under freezing point.

It is another object of the present invention to provide an antifogging article having such antifogging film formed on a substrate.

It is still another object of the present invention to provide a method for forming an antifogging film on a substrate by using the coating agent.

According to the present invention, there is provided a two-package coating agent for forming an antifogging film. This coating agent comprises:
a first coating agent comprising an isocyanate component containing an isocyanate group; and
a second coating agent comprising (a) a polyol component comprising at least a water-absorbing polyol and a hydrophobic polyol and (b) a surfactant comprising a group that is reactive with the isocyanate group.

According to the present invention, there is provided an antifogging article comprising (a) a substrate; and (b) an antifogging, urethane resin film formed on the substrate. The urethane resin film comprises a hydrophobic component from the hydrophobic polyol, a water-absorbing component from the water-absorbing polyol, and a surfactant bonded to the urethane resin crosslinked structure. The urethane resin film has a water-absorbing property to exhibit antifogging property and is such that, when water is brought into contact with the urethane resin film after saturation of the urethane resin film with water, a water film is formed on the urethane resin film to maintain antifogging property.

According to the present invention, there is provided a method for forming an antifogging film on a substrate. This method comprises the steps of:
(a) providing a first coating agent comprising an isocyanate component containing an isocyanate group;
(b) providing a second coating agent comprising (1) a polyol component comprising at least a water-absorbing polyol and a hydrophobic polyol and (2) a surfactant containing a group that is reactive with the isocyanate group;
(c) mixing the first and second coating agents together to prepare a coating agent;
(d) applying the coating agent to the substrate to form a precursory film on the substrate; and
(e) hardening the precursory film under room temperature or heating into the antifogging film.

### DESCRIPTION OF THE PREFERRED EMBODIMENTS

The above-mentioned coating agent of the present invention is of a two-package type. In other words, the first and second coating agents are mixed together upon use.

The above surfactant of the second coating agent, which contains a group (e.g., hydroxyl group, amino group, and mercapto group) that is reactive with the isocyanate group, contributes to maintaining antifogging property of an antifogging film of the present invention. Hereinafter, this group is referred to as “isocyanate-reactive group”. Since the antifogging film (made from the coating agent of the present invention) has water-absorbing property, water is absorbed into the antifogging film at the initial stage to exhibit antifogging property (e.g., the initial stage in mist). This water absorption contributes to exhibiting antifogging property. As mist or the like continues, the antifogging film may become saturated with water. If it continues further after saturation, a water film is formed by the surfactant on the antifogging film to maintain antifogging property. Since the surfactant contains an isocyanate-reactive group, the surfactant is bonded at its isocyanate-reactive group to the urethane resin crosslinked structure after the hardening of the coating agent (precursory film). Therefore, the surfactant is not easily removed from the antifogging film, thereby making the antifogging film superior in durability and in maintaining antifogging property.

The surfactant (containing an isocyanate-reactive group) may be in an amount of 10-25 wt %, based on the total weight (100 wt %) of the isocyanate component, the polyol component, and the surfactant. Hereinafter, these three components may be referred to as “the urethane components”. If it is less than 10 wt %, the maintenance of antifogging property may be impaired. If it is greater than 25 wt %, the antifogging film may become insufficient in strength.

The water-absorbing polyol of the second coating agent contributes to exhibiting antifogging property due to water absorption into the antifogging film. In view of exhibiting antifogging property at under freezing point, the water-absorbing polyol is preferably a polyoxyalkylene. In this case, polyoxyalkylene chains are introduced into the antifogging film after hardening of the coating agent. Oxygen atoms in the polyoxyalkylene chains absorb and maintain water molecules as “bound water” or “combined water”. Such bound water does not easily freeze even at under freezing point, thereby providing antifogging property under freezing point (e.g., from −30° C. to 0° C.).

The water-absorbing polyol may be in an amount of 10-25 wt %, based on the total weight (100 wt %) of the urethane components. If it is less than 10 wt %, antifogging property due to water absorption may become insufficient. If it is greater than 25 wt %, there may arise some disadvantages (e.g., inferiority in hardening of the coating agent and in antifogging film strength).

In order to exhibit antifogging property at under freezing point, it is preferable that the polyoxyalkylene as the water-absorbing polyol is a polyethylene glycol having an average molecular weight of 400-2,000 or a mixture of (a) a polyethylene glycol having an average molecular weight of 400-2,000 and (b) a polyol that is a copolymer of oxyethylene and oxypropylene and that has an average molecular weight of 1,500-5,000. Hereinafter, this polyol may be referred to as “oxyethylene/oxypropylene copolymer polyol”. In the present invention, the average molecular weight refers to “number average molecular weight”.

A polyethylene glycol having an average molecular weight less than 400 may be inferior in capability for absorbing water as bound water. Therefore, the antifogging film may become inferior in antifogging property under freezing point. The use of a polyethylene glycol having an average molecular weight exceeding 2,000 may cause some disadvantages (e.g., inferiority in hardening of the coating agent and in antifogging film strength).

Although the above-mentioned oxyethylene/oxypropylene copolymer polyol may be inferior to the above polyethylene glycol (average molecular weight: 400-2,000) in water absorption, the former can improve the antifogging film in water resistance. Therefore, it is possible to use a mixture of the oxyethylene/oxypropylene copolymer polyol and the polyethylene glycol to improve the antifogging film in water absorption and water resistance. As stated above, it is preferable that the oxyethylene/oxypropylene copolymer polyol has an average molecular weight of 1,500-5,000 in view of water absorption and water resistance.

In the preparation of the oxyethylene/oxypropylene copolymer polyol, the ratio of oxyethylene to oxypropylene is not particularly limited. This copolymer polyol may be added to the extent that the total weight of the oxyethylene chains in the water-absorbing polyol is 10 wt % or more, based on the total weight (100 wt %) of the urethane components.

The hydrophobic polymer of the second coating agent can contribute to wear resistance and water resistance of the antifogging film. It may be in an amount of 2.5-40 wt %, based on the total weight (100 wt %) of the urethane components. If it is less than 2.5 wt %, wear resistance may become inferior. If it exceeds 40 wt %, antifogging property may become inferior.

The hydrophobic polyol is preferably a polyester polyol having an average molecular weight of 500-2,000. This polyester polyol has both flexibility and scratch resistance, thereby improving the antifogging film in wear resistance without damaging antifogging property. If its average molecular weight is less than 500, the antifogging film may become too compact and may be lowered in wear resistance. If its average molecular weight is greater than 2,000, it may be difficult to form the coating agent into an antifogging film. In view of compactness of the antifogging film, it is preferable that the hydrophobic polyol has two or three hydroxyl groups in the molecule.

The polyester polyol may be selected from polycarbonate polyols, polycaprolactone polyols, and mixtures of these.

In addition to the water-absorbing polyol and the hydrophobic polyol, the polyol component may further contain a short chain polyol having an average molecular weight of 60-200. The short chain polyol has a function of extending the chain length of the urethane polymer of the antifogging film, thereby improving hardenability of the antifogging film without damaging its elasticity. If its average molecular weight is less than 60, the antifogging film may become inferior in elasticity. If it is greater than 200, the antifogging film may become inferior in hardenability.

The short chain polyol may be in an amount of 2.5-10 wt %, based on the total weight (100 wt %) of the urethane components. If it is less than 2.5 wt %, the hardening acceleration effect may become insufficient. If it exceeds 10 wt %, it may become necessary to increase the amount of the isocyanate in proportion to the amount of the short chain polyol, since the chance of the reaction between the isocyanate groups and the short chain polyol molecules increases. Therefore, the antifogging film may become too compact and may become inferior in wear resistance due to low elasticity and in antifogging property due to low water absorption capability.

In addition to the polyol component and the surfactant, the second coating agent may further contain (a) a precursor of a metal oxide and (b) a silane coupling agent containing a group (hereinafter “isocyanate-reactive group”) that is reactive with the isocyanate group of the isocyanate, in order to improve wear resistance of the antifogging film. The precursor can have a hydrolysable group such as alkoxy group, oxyhalogen group, and acetyl group. During the hardening of the coating agent (precursory film) into the antifogging film, the metal oxide precursor having a hydrolysable group is subjected to hydrolysis and then polycondensation, thereby making a chemical bond with the silane coupling agent. Thus, the resulting metal oxide is chemically bonded to the urethane resin of the antifogging film through the silane coupling agent. Furthermore, at least one of the first and second coating agents may further contain metal oxide particles having an average particle size of 5-50 nm, in order to improve scratch resistance of the antifogging film.

As stated above, an antifogging film according to the present invention is a urethane resin based film containing (a) a hydrophobic component derived from a hydrophobic polyol, (b) a water-absorbing component (preferably containing oxyethylene chain) derived from a water-absorbing polyol, and (c) a surfactant. This antifogging film has superior properties.

In the above-mentioned method for forming an antifogging film, the heating of the step (e) may be conducted at a temperature of 170° C. or lower, preferably 80-170° C. It is possible to efficiently obtain an antifogging film by the method.

The isocyanate component of the first coating agent may be a diisocyanate, preferably a biuret obtained from hexamethylenediisocyanate and/or a trifunctional polyisocyanate having an isocyanurate structure. Such isocyanate is effective for providing weather resistance, chemical resistance, and heat resistance, particularly weather resistance. Other examples of the isocyanate include diisophorone diisocyanate, diphenylmethane diisocyanate, bis(methylcyclohexyl)diisocyanate, and toluene diisocyanate.

The ratio of the number of the isocyanate groups of the isocyanate to the total number of the isocyanate-reactive groups (e.g., hydroxyl group, mercapto group, and amino group), which are contained in the polyol component and the surfactant, may be adjusted to from 0.8 to 2, preferably from 0.9 to 1.3. If it is less than 0.8, the coating agent may become inferior in hardenability. Furthermore, there may arise some disadvantages such as sticky feeling of the antifogging film due to the exposure of the unreacted surfactant on the surface of the antifogging film. If it exceeds 2, hardening may proceed too much, thereby lowering antifogging property.

The surfactant can provide the antifogging film with hydrophilicity and antifogging property and has an isocyanate-reactive group (e.g., hydroxyl group, mercapto group, and amino group). The surfactant may be selected from cationic surfactants, anionic surfactants, amphoteric surfactants, and nonionic surfactants. These surfactants may be used singly or in combination.

The anionic surfactant containing an isocyanate-reactive group may be selected from castor oil monosulfate, castor oil monophosphate, sorbitan fatty acid ester sulfate, sorbitan fatty acid ester phosphate, sorbitol fatty acid ester sulfate, sorbitol fatty acid ester phosphate, sucrose fatty acid ester sulfate, sucrose fatty acid ester phosphate, polyoxyalkylene castor oil ether monosulfate, polyoxyalkylene castor oil ether monophosphate, polyoxyalkylene sorbitan fatty acid ester sulfate, polyoxyalkylene sorbitan fatty acid ester phosphate, polyoxyalkylene glycerin ether monosulfate, and polyoxyalkylene glycerin ether monophosphate.

The cationic surfactant containing an isocyanate-reactive group may be selected from dialkanolamine salts, trialkanolamine salts, polyoxyalkylene alkylamine ether salts, trialkanolamine fatty acid ester salts, polyoxyalkylene dialkanolamine ether salts, polyoxyalkylene trialkanolamine ether salts, di(polyoxyalkylene)alkylbenzylalkylammonium salts, alkylcarbamoylmethyldi(polyoxyalkylene)ammonium salts, polyoxyalkylenealkylammonium salts, polyoxyalkylene-dialkylammonium salts, and ricinoleamidepropylethyldimonium ethosulfato.

The amphoteric surfactant containing an isocyanate-reactive group may be selected from N,N-di(β-hydroxyalkyl)-N-hydroxyethyl-N-carboxyalkylammonium betaine, N-β-hydroxyalkyl-N,N-dipolyoxyalkylene-N-carboxyalkylammonium betaine, N-alkyl-N,N-di(polyoxyalkylene) amine dicarboxylic acid monoesters, N-(polyoxyethylene)-N′,N′-di(polyoxyethylene) aminoalkyl-N-alkyl-N-sulfoalkylammonium betaine, N,N-di(polyoxyethylene)-N-alkyl-N-sulfoalkyleneammonium betaine, N-(β-hydroxyalkylaminoethyl)-N-(β-hydroxyalkyl)aminoethylcarboxylic acid, N,N′-bis(2-hydroxyalkyl)-N,N′-bis(carboxyethyl)ethylenediamine salts, and N-(β-hydroxyalkyl)-N′,N′-di(polyoxyethylene)-N-carboxyethylethylenediamine salts.

The nonionic surfactant containing an isocyanate-reactive group may be selected from polyoxyethylene-polyoxypropylene block polymer, sorbitol fatty acid esters, sorbitan fatty acid esters, sucrose fatty acid esters, polyoxyalkylene sorbitan fatty acid esters, fatty acid monoglycerides, polyoxyalkylene fatty acid monoglycerides, polyglycerin fatty acid esters, polyoxyalkylene castor oil ethers, polyoxyalkylene alkylamines, and polyoxyalkylene alkylamides.

As mentioned above, the polyol component may further contain a short chain polyol having an average molecular weight of 60-200. It is preferable that the short chain polyol has two or three hydroxyl groups per molecule. If the number of hydroxyl groups is less than 2, the antifogging film may become brittle since the short chain polyol may not serve as a skeletal component of the antifogging film. If it is greater than 3, the reactivity may become too high, thereby making the coating agent unstable.

The short chain polyol may be selected from ethylene glycol, propylene glycol, 1,3-propanediol, 1,2-butanediol, 1,3-butanediol, 1,4-butanediol, 2,3-butanediol, 1,5-pentanediol, 2-butene-1,4-diol, 2-methyl-2,4-pentanediol, 2-ethyl-1,3-hexanediol, diethylene glycol, dipropylene glycol, triethylene glycol, glycerol, 2-ethyl-2-(hidroxymethyl)-1,3-propanediol, 1,2,6-hexanetriol, and 2,2′-thiodiethanol. These polyols may be used singly or in combination, and a copolymer of at least two of these may also be used.

The short chain polyol can lower the surface friction coefficient of an antifogging film to allow substances (adherers) that are adherent to the antifogging film to slip down its surface. With this, the antifogging film is improved in scratch resistance and stain resistance. In contrast, if its surface friction coefficient is too high, it may become necessary to wipe the antifogging film to remove the adherers therefrom. With this, the antifogging film may have scratches. Hereinafter, the capability of the antifogging film to allow the adherers to slip down its surface may be referred to as “slipping property”.

In general, antifogging films may be lowered in antifogging property by introducing a component(s) (e.g., hydrophobic polyol and short chain polyol) that improves durability of the antifogging films. In particular, it may be difficult to have antifogging property at under freezing point by introducing the above component. The inventors, however, unexpectedly found that it is possible to obtain an antifogging film having good properties (such as durable antifogging property, antifogging property at under freezing point, slipping property, and wear resistance) by using the surfactant (preferably in an amount of 10-25 wt % as stated above) and the water-absorbing polyol (preferably in an amount of 10-25 wt % as stated above) together with the above component(s). In other words, the introduction of the surfactant and the water-absorbing polyol unexpectedly can remove the above-mentioned demerit that may be caused by introducing the above component(s).

In order to improve the antifogging film in wear resistance, the second coating agent may further contain at least one of (a) a precursor of a metal oxide and (b) a silane coupling agent containing an isocyanate-reactive group. The precursor may be selected from alkoxides (e.g., ethoxides and methoxides), oxyhalides, and acetyl-containing compounds. The metal oxide may be at least one selected from silica, titania, zirconia, alumina, niobium oxide, and tantalum oxide. Of these, silica is particularly preferable in terms of economical point of view. The precursor may be in a weight that is 1.25 times the total weight of the urethane components or less. If it is in excess of 1.25 times that, the antifogging film may become insufficient in antifogging property. In terms of improving wear resistance, the precursor is preferably in a weight that is at least 0.1 times that.

The silane coupling agent may be in a weight that is 0.25 times the total weight of the urethane components or less. If it is in excess of 0.25 times that, there may arise some problems (such as (a) lowering of the antifogging film in strength due to the unreacted functional group of the silane coupling agent and (b) occurrence of sticky feeling of the antifogging film surface). From the viewpoint of achieving crosslinking between the metal oxide and the urethane resin, the silane coupling agent may be at least 0.01 times the total weight of the urethane components. The silane coupling agent is particularly preferably 3-methacryloxypropyltrimethoxysilane or 3-glycidoxypropyltrimethoxysilane, since these compounds can provide a homogeneous antifogging film.

In order to improve scratch resistance of the antifogging film, at least one of the first and second coating agents may further contain metal oxide particles having an average particle size of 5-50 nm. The metal oxide particles may be those of silica, titania, zirconia, alumina, niobium oxide, and tantalum oxide. In particular, it is preferably colloidal silica. In the case of introducing the metal oxide particles, it is preferable to adjust the amount of the metal oxide particles in order to have a sufficient antifogging property. Thus, it may be 40 wt % or less, preferably 20 wt % or less, more preferably 10 wt % or less, based on the total weight (100 wt %) of the urethane components. The average particle size of the metal oxide particles may be defined as follows. At first, a section of the antifogging film is observed with a scanning electron microscope (SEM) of 100,000 magnifications. In this observation, the particle sizes of all the metal oxide particles present in a 1 μm square area in the SEM image are measured and averaged. This is repeated 20 times to determine the average particle size of the metal oxide particles.

Upon use of the two-package coating agent, the first and second coating agents are mixed together. With this, the isocyanate group of the first coating agent may be reacted with hydroxyl group, mercapto group and amino group of the second coating agent, thereby forming a urethane bond and a urethane resin.

It is optional to add a diluting solvent to each component in the preparation of the two-package coating agent or to the prepared two-package coating agent. The diluting solvent is not particularly limited as long as it is inert to the isocyanate group. It is preferably methyl propylene glycol or diacetone alcohol from the viewpoint of compatibility of the components of the two-package coating agent or of the first and second coating agents.

The coating agent obtained by mixing the first and second coating agents together is applied to a substrate to form a precursory film on the substrate. This application may be a known one, such as dip coating, flow coating, spin coating, roller coating, spraying, screen printing, and flexography. After the application, the precursory film is hardened under room temperature (e.g., about 20° C.) or heating (e.g., of 170° C. or lower) into an antifogging film. If it exceeds 170° C., there may arise some problems such as carbonization of the urethane resin and lowering of the antifogging film strength. The heating may be conducted at a temperature of 80-170° C. in order to accelerate the hardening of the precursory film.

It is preferable to adjust the thickness of the antifogging film after the hardening to about from 5 μm to about 40 μm. If it is less than 5 μm, the antifogging film may become inferior in durability. If it exceeds 40 μm, the antifogging film may have a problem such as optical distortion in external appearance of the antifogging film.

Although the substrate is not limited to a particular material, it may be glass. Furthermore, it may be in the form of glass plate for automotive, architectural and other industrial uses. Its production method may be selected from float method, duplex method, and rollout method. Furthermore, it may be selected from clear and various color glass plates (e.g., of green and bronze), various functional glass plates (e.g., UV shielding glass, IR shielding glass, electromagnetic shielding glass), glass plates usable for fire-retarding glasses (e.g., wired glass, low-expansion glass, and zero expansion glass), mirrors produced by silvering and vacuum deposition, and flat and bent glass plates. Although the thickness of the substrate is not particularly limited, it may be from 1.0 mm to 10 mm, preferably from 1.0 mm to 5.0 mm for vehicular use. The antifogging film may be formed on a part or the entirety of only one or both major surfaces of a substrate.

The substrate is not limited to glass and may be selected from resin films (e.g., of polyethylene terephthalate), resins (e.g., polycarbonate), and metals (particularly metal mirror), and ceramics.

The two-package coating agent of the present invention can be used for architectural uses (e.g., interior mirrors and mirrors and window glasses for bath room, washroom, etc.); vehicular, watercraft and aircraft uses (e.g., window glasses and mirrors such as rearview mirror and door mirror); and other uses (e.g., lens of eyeglasses and cameras, goggles, helmet shields, refrigerator showcases, freezer showcases, opening glasses and sight glasses of testers and precision apparatuses, road reflectors, and mobile communication device (e.g., cellular phone) displays) and the like.

As stated above, the antifogging film of the present invention is superior in antifogging property at under freezing point. Therefore, it is particularly effective for outdoor uses under freezing point, such as vehicular, watercraft and aircraft window glasses and mirrors, road reflectors, mobile communication device displays and the like. In the case of using the above-mentioned short chain polyol in the preparation of the two-package coating agent, the resulting antifogging film becomes superior in slipping property. In other words, the antifogging film does not easily have contaminants thereon, and the adhered contaminants can easily be removed therefrom by wiping or the like. Thus, such antifogging film is particularly superior in wear resistance and stain resistance.

The following nonlimitative Examples are illustrative of the present invention.

### EXAMPLE 1

A solution (“VISGARD-B” of Film Specialties Co.) containing 73 wt % of hexamethylenediisocyanate was prepared as a first coating agent of the present invention.

Separately, there was prepared a first solution (“VISGARD-A” of Film Specialties Co.) containing 27 wt % of the total of 63 parts by weight of a surfactant containing an isocyanate-reactive group (i.e., a sulfonic acid amine salt) and 37 parts by weight of a water-absorbing polyol (i.e., an ethyleneoxide/propyleneoxide copolymer polyol having an average molecular weight of 2,100-4,500). Furthermore, a polyethylene glycol (water-absorbing polyol) having an average molecular weight of 1,000 was prepared. Furthermore, there was prepared a second solution (“PC-61” of NIPPON POLYURETHANE INDUSTRY CO., LTD.) containing 80 wt % of a polycarbonate polyol (hydrophobic polyol) having an average molecular weight of 1,250.

Then, the above first and second solutions and the above polyethylene glycol were mixed together in a manner to prepare a second coating agent of the present invention containing 70 parts by weight of the total of the sulfonic acid amine salt and the ethyleneoxide/propyleneoxide copolymer polyol, 10 parts by weight of the polyethylene glycol, and 20 parts by weight of the polycarbonate polyol.

Then, 42 parts by weight of the above first coating agent were mixed with 100 parts by weight of the above second coating agent. The resulting mixture was diluted with diacetone alcohol as a diluting solvent in a manner to prepare a coating agent containing 35 wt % of the total of the urethane components.

Then, the coating agent was applied to a float glass plate (widths: 100 mm; thickness: 2 mm) by a spin coating, followed by heating at 150° C. for about 30 min, thereby forming an antifogging film (thickness: 20 μm) thereon.

The obtained test sample (antifogging article), particularly its antifogging film, was subjected to the following evaluation tests. The results are shown in Table.

An external appearance evaluation test was conducted by observing the antifogging film with naked eyes. It was judged as being “Good” if it is satisfactory in external appearance and transparency and is free of cracks. It was judged as being “Not Good” if it is not satisfactory in external appearance and transparency and has cracks.

A repetitive antifogging test was conducted in accordance with Japanese Industrial Standard (JIS) S 4030, of which disclosure is incorporated herein by reference in its entirety, as follows. In this test, a first step was conducted by retaining the test sample in water vapor of warm water of 43° C. for 3 minutes, and then a second step was conducted by moving the test sample from the water vapor to an environment (temperature: 23° C.; relative humidity: 63%) and then by blowing breath against the test sample, thereby completing one cycle. The first and second steps were conducted alternately to complete ten cycles. The test sample was judged to be “good” when the external appearance did not change and when fogging did not occur after each first step and each second step. On the other hand, it was judged to be “not good” when fogging occurred.

An antifogging test under freezing point was conducted by a first step of allowing the test sample to stand still in a refrigerator of −20° C. for 30 min, then by a second step of moving the test sample from the refrigerator to an environment (temperature: 23° C.; relative humidity: 63%), then by a third step of observing the external appearance (including fogging condition) of the antifogging film immediately after the second step, and then by a fourth step of observing fogging condition after blowing breath against the test sample, thereby completing one cycle. The first to fourth steps were conducted sequentially to complete ten cycles. The test sample was judged to be “good” when the external appearance did not change and when fogging did not occur after each third step and each fourth step. On the other hand, it was judged to be “not good” when fogging occurred.

A first wear resistance test (Taber test) was conducted by rotating 500 cycles relative to a 5130-type Taber abraser (of Taber Co.) having an abrasive wheel CS-10F, while the abrasive wheel was in abutment with the test sample under a load of 2.45N. The haze value was measured before and after the first wear resistance test. In Table, “Good” means that ΔH was 10% or less where ΔH=H₅₀₀−H₀ (H₅₀₀: the haze value after the 500 cycles; H₀: the haze value before the test), and “Not Good” means that ΔH was greater than 10%).

A second wear resistance test (traverse test) was conducted by moving a cotton flannel (No. 300) on the test sample in a reciprocative manner under a load of 4.9 N/4 cm² to complete 5,000 reciprocations. The test sample was judged as being “good”, when no abnormality was found in the external appearance and when no fogging was observed by blowing breath against the test sample after the second wear resistance. It was judged as being “not good”, when abnormality was found in the external appearance or when fogging was observed.

A pencil hardness test was conducted on the test sample in accordance with JIS K 5400, of which disclosure is incorporated herein by reference in its entirety. In this test, the antifogging film was scratched 5 times with each of several pencils (having respective symbols corresponding to their hardnesses or blacknesses) under a load of 1 kg. The symbol of a pencil, which had broken the antifogging film less than two times in this test, was recorded as the result. The result of this pencil hardness test is indicative of scratch resistance. In other words, greater pencil hardness as the result of this test means greater scratch resistance of the antifogging film. The pencil symbols in terms of hardness ranks are in the descending order of 9H>8H>7H>6H>5H>4H>3H>2H>H>F>HB>B>2B>3B>4B>5B>6B.

A water resistance test was conducted by immersing the test sample in water of 23±2° C. for 1 hr. The test sample was judged to be “good” when no abnormality was found in the external appearance of the test sample after the water resistance test. It was judged to be “not good” when abnormality was found. Furthermore, the above pencil hardness test was conducted again after the water resistance test. The test sample was judged as being “good” when the pencil hardness after the water resistance test had not lowered or had lowered by only one rank of the pencil hardness symbol, as compared with that before the water resistance test. In contrast, it was judged as “not good” when it had lowered by two ranks or more. It is understood from Table that it lowered by only one rank (H→F) in Example 1 and in contrast five ranks (HB→5B) in Comparative Example 1.

A slipping property evaluation test was conducted in accordance with JIS K 7125, of which disclosure is incorporated herein by reference in its entirety. In this test, static friction coefficient was determined by putting a rectangular slipping piece (having widths of 6.3 cm and a touch area of 40 cm²) on the antifogging film of the test piece under a load of 200 g in a manner that a cotton flannel (No. 300) covering the rectangular slipping piece was in contact with the antifogging film. The test sample was judged as being “good” when static friction coefficient was 0.8 or less. In contrast, it was judged as being “not good” when it exceeded 0.8. Lower static friction coefficient is preferable in order to improve durability of the antifogging film due to the provision of slipping property. Static friction coefficient can be from 0.4 to 0.8 in order to achieve both slipping property and antifogging property.

TABLE

| | | | | | 2^{nd} Wear | | External | Pencil | |
|---|---|---|---|---|---|---|---|---|---|
| | | | Antifogging | 1^{st} Wear | Resistance | | Appearance | Hardness | |
| | | Repetitive | Test under | Resistance | Test | | after Water | after Water | |
| | External | Antifogging | Freezing | Test | (Traverse | Pencil | Resistance | Resistance | Slipping |
| | Appearance | test | Point | (Taber Test) | Test) | Hardness | Test | Test | Property |
| Ex. 1 | Good | Good | Good | Good | Good | H | Good | Good (F) | Good |
| Ex. 2 | Good | Good | Good | Good | Good | F | Good | Good (HB) | Good |
| Ex. 3 | Good | Good | Good | Good | Good | F | Good | Good (HB) | Good |
| Ex. 4 | Good | Good | Good | Good | Good | H | Good | Good (F) | Good |
| Ex. 5 | Good | Good | Good | Good | Good | H | Good | Good (H) | Good |
| Ex. 6 | Good | Good | Good | Good | Good | H | Good | Good (H) | Good |
| Ex. 7 | Good | Good | Good | Good | Good | HB | Good | Good (HB) | Good |
| Ex. 8 | Good | Good | Good | Good | Good | H | Good | Good (F) | Good |
| Ex. 9 | Good | Good | Good | Good | Good | F | Good | Good (HB) | Good |
| Ex. 10 | Good | Good | Good | Good | Good | H | Good | Good (F) | Good |
| Ex. 11 | Good | Good | Good | Good | Good | F | Good | Good (HB) | Good |
| Ex. 12 | Good | Good | Good | Good | Good | H | Good | Good (H) | Good |
| Ex. 13 | Good | Good | Good | Good | Good | H | Good | Good (H) | Good |
| Ex. 14 | Good | Good | Good | Good | Good | H | Good | Good (H) | Good |
| Ex. 15 | Good | Good | Good | Good | Good | F | Good | Good (HB) | Good |
| Ex. 16 | Good | Good | Good | Good | Good | F | Good | Good (HB) | Good |
| Com. Ex. 1 | Good | Good | Not Good | Good | Not Good | HB | Good | Not Good | Good |
| | | | | | | | | (5B) | |
| Com. Ex. 2 | Good | Good | Good | Good | Not Good | B | Good | Good (B) | Not Good |
| Com. Ex. 3 | Good | Not Good | Not Good | Good | Good | H | Good | Good (H) | Good |
| Com. Ex. 4 | Good | Good | Not Good | Good | Good | H | Good | Good (H) | Good |
| Com. Ex. 5 | Good | Not Good | Not Good | Good | Gpod | F | Good | Not Good | Good |
| | | | | | | | | (2B) | |
| Com. Ex. 6 | Good | Not Good | Not Good | Good | Good | H | Good | Good (H) | Good |

### EXAMPLE 2

Example 1 was slightly modified as follows. The first and second solutions and the polyethylene glycol were mixed together in a manner to prepare a second coating agent of the present invention containing 50 parts by weight of the total of the sulfonic acid amine salt and the ethyleneoxide/propyleneoxide copolymer polyol, 30 parts by weight of the polyethylene glycol, and 20 parts by weight of the polycarbonate polyol. Then, 43 parts by weight of the first coating agent were mixed with 100 parts by weight of the second coating agent. The coating agent was applied in a manner similar to Example 1, thereby forming an antifogging film (thickness: 18 μm).

### EXAMPLE 3

Example 1 was slightly modified as follows. The first and second solutions and the polyethylene glycol were mixed together in a manner to prepare a second coating agent of the present invention containing 30 parts by weight of the total of the sulfonic acid amine salt and the ethyleneoxide/propyleneoxide copolymer polyol, 30 parts by weight of the polyethylene glycol, and 40 parts by weight of the polycarbonate polyol. Then, 46 parts by weight of the first coating agent were mixed with 100 parts by weight of the second coating agent. The coating agent was applied in a manner similar to Example 1, thereby forming an antifogging film (thickness: 19 μm).

### EXAMPLE 4

A biuret-type polyisocyanate of hexamethylenediisocyanate, that is, “N3200” of Sumitomo Bayer Urethane Co., was prepared as a first coating agent of the present invention.

Separately, a second coating agent of the present invention was prepared by mixing together (a) 12.5 g of ricinoleamidepropylethyldimonium ethosulfato (“LipoquatR” of Lipo Chemicals Inc.) as a surfactant containing an isocyanate-reactive group, (b) 17.5 g of polyethylene glycol (average molecular weight: 1,000) as a water-absorbing polyol, (c) 20.5 g of polycaprolactone diol (average molecular weight: 1,250), that is, “PLACCEL L212AL” of DAICEL CHEMICAL INDUSTRIES, LTD., as a hydrophobic polyol, and (d) 5 g of 1,4-butanediol as a short chain polyol of the present invention.

Then, 44.5 g of the first coating agent were mixed with 55.5 g of the second coating agent such that the ratio of the number of the isocyanate groups to the number of the isocyanate-reactive groups was 1.2 and that the total weight of the urethane components (i.e., the total weight of the first and second coating agents) was 100 g, thereby preparing a mixture. Then, diacetone alcohol was added as a diluting solvent to the mixture to adjust the concentration of the urethane components to 35 wt %. Furthermore, dibutyltin dilaurate (hardening catalyst) in an amount of 0.005 wt %, based on the total weight of the urethane components, was added, thereby preparing a coating agent. Then, the same steps as those of Example 1 were repeated, thereby obtaining an antifogging film (thickness: 28 μm).

### EXAMPLE 5

Example 4 was repeated except that polycaprolactone diol (average molecular weight: 500), that is, “PLACCEL L205AL” of DAICEL CHEMICAL INDUSTRIES, LTD., was used in an amount of 15 g as a hydrophobic polyol in place of that of Example 4 and that 50 g of the first coating agent were mixed with 50 g of the second coating agent. That is, the total weight of the urethane components was 100 g. The obtained antifogging film was 28 μm in thickness.

### EXAMPLE 6

Example 4 was repeated except that the preparation of the second coating agent was modified by using 20.0 g of the surfactant, 20.0 g of the water-absorbing polyol, 5.6 g of the hydrophobic polyol, and 5 g of ethylene glycol as a short chain polyol of the present invention and that 49.4 g of the first coating agent were mixed with 50.6 g of the second coating agent such that the ratio of the number of the isocyanate groups to the number of the isocyanate-reactive groups was 1.1. The total weight of the urethane components was 100 g. The obtained antifogging film was 26 μm in thickness.

### EXAMPLE 7

Example 6 was repeated except that the preparation of the second coating agent was modified by using 20.0 g of the surfactant, 20.0 g of the water-absorbing polyol, 19.5 g of the hydrophobic polyol, and 2.5 g of glycerol as a short chain polyol of the present invention and that 38 g of the first coating agent were mixed with 62 g of the second coating agent such that the ratio of the number of the isocyanate groups to the number of the isocyanate-reactive groups was 1.1. The total weight of the urethane components was 100 g. The obtained antifogging film was 30 μm in thickness.

### EXAMPLE 8

Example 7 was repeated except that the preparation of the second coating agent was modified by using 20.0 g of the surfactant, 20.0 g of the water-absorbing polyol, 5.1 g of a polycarbonate triol as the hydrophobic polyol, and 5 g of ethylene glycol as a short chain polyol of the present invention and that 49.9 g of the first coating agent were mixed with 50.1 g of the second coating agent. The total weight of the urethane components was 100 g. The obtained antifogging film was 30 μm in thickness.

### EXAMPLE 9

Example 6 was repeated except that the preparation of the second coating agent was modified by using 20.0 g of the surfactant, 20.0 g of the water-absorbing polyol, 8.3 g of a polycaprolactone triol (average molecular weight: 500), that is, “PLACCEL 305” of DAICEL CHEMICAL INDUSTRIES, LTD., as the hydrophobic polyol, and 5 g of 1,4-butanediol as the short chain polyol and that 46.7 g of the first coating agent were mixed with 53.3 g of the second coating agent. The total weight of the urethane components was 100 g. The obtained antifogging film was 33 μm in thickness.

### EXAMPLE 10

Example 4 was repeated except that the preparation of the second coating agent was modified by using (a) 17.5 g of the surfactant, (b) 15.0 g of the polyethylene glycol and 10 g of an propylene oxide/ethylene oxide random triol (ethylene oxide content: 50%; average molecular weight: 2,800) as water-absorbing polyols, (c) 13.2 g of a polycaprolactone diol (average molecular weight: 500) as the hydrophobic polyol, and (d) 2.5 g of glycerol as the short chain polyol and that 41.9 g of the first coating agent were mixed with 58.2 g of the second coating agent such that the ratio of the number of the isocyanate groups to the number of the isocyanate-reactive groups was 1.2. The total weight of the urethane components was 100 g. The obtained antifogging film was 32 μm in thickness.

### EXAMPLE 11

Example 6 was modified as follows. To the second coating agent of Example 6, (a) 71.4 g of ethyl silicate (as a metal oxide precursor of the present invention), (b) 30 g of 3-methacryloxypropyltrimethoxysilane (as a silane coupling agent of the present invention) made by Kishida Chemical Co., and (c) 3 g of 0.1N nitric acid were additionally. Diacetone alcohol was added as a diluting solvent to a mixture of the first and second coating agents to adjust the concentration of the total of the urethane components, the metal oxide precursor, and the silane coupling agent to 35 wt %. Furthermore, dibutyltin dilaurate (hardening catalyst) in an amount of 0.005 wt %, based on the total weight of the urethane components, was added, thereby preparing a coating agent. The obtained antifogging film was 27 μm in thickness.

### EXAMPLE 12

Example 4 was modified as follows. To the second coating agent of Example 4, (a) 28.6 g of ethyl silicate (as a metal oxide precursor of the present invention) made by Kishida Chemical Co., (b) 14.3 g of 3-methacryloxypropyltrimethoxysilane (as a silane coupling agent of the present invention), and (c) 1 g of 0.1N nitric acid were additionally added. Diacetone alcohol was added as a diluting solvent to a mixture of the first and second coating agents to adjust the concentration of the total of the urethane components, the metal oxide precursor, and the silane coupling agent to 35 wt %. Furthermore, dibutyltin dilaurate (hardening catalyst) in an amount of 0.005 wt %, based on the total weight of the urethane components, was added, thereby preparing a coating agent. The obtained antifogging film was 28 μm in thickness.

### EXAMPLE 13

Example 12 was repeated except that the amounts of ethyl silicate, 3-methacryloxypropyltrimethoxysilane and 0.1N nitric acid were respectively changed to 11.7 g, 5.9 g, and 0.3 g. The obtained antifogging film was 27 μm in thickness.

### EXAMPLE 14

Example 6 was repeated except that 48 g of a silica fine particles solution (i.e., “NPC-ST” made by NISSAN CHEMICAL INDUSTRIES, LTD.) containing 20 wt % of silica fine particles (average particle size: 10 nm) dispersed in ethylene glycol monopropyl ether were additionally added to the second coating agent of Example 6. The obtained antifogging film was 27 μm in thickness.

### EXAMPLE 15

Example 4 was repeated except that the preparation of the second coating agent was modified by using 17.5 g of the surfactant, 20.0 g of the water-absorbing polyol, 4.7 g of the hydrophobic polyol, and 7.5 g of triethanolamine as the short chain polyol and that 50.3 g of the first coating agent were mixed with 49.7 g of the second coating agent. The total weight of the urethane components was 100 g. The obtained antifogging film was 28 μm in thickness.

### EXAMPLE 16

Example 4 was repeated except that the preparation of the second coating agent was modified by using 17.5 g of the surfactant, 20.0 g of the water-absorbing polyol, 10.5 g of a polycaprolactone diol (average molecular weight: 500) as the hydrophobic polyol, and 5 g of triethanolamine as the short chain polyol and that 47 g of the first coating agent were mixed with 53 g of the second coating agent. The total weight of the urethane components was 100 g. The obtained antifogging film was 32 μm in thickness.

### COMPARATIVE EXAMPLE 1

Example 1 was repeated except that the water-absorbing polyol and the hydrophobic polyol were omitted in the preparation of the second coating agent and that 40 parts by weight of the first coating agent were mixed with 100 parts by weight of the second coating agent. The obtained antifogging film was 22 μm in thickness.

### COMPARATIVE EXAMPLE 2

Example 4 was repeated except that the short chain polyol was omitted and the hydrophobic polyol was in an amount of 42.5 g in the preparation of the second coating agent and that 27.5 g of the first coating agent were mixed with 72.5 g of the second coating agent. The total weight of the urethane components was 100 g. The obtained antifogging film was 28 μm in thickness. As shown in Table, the cotton flannel adhered to the antifogging film and thereby the external appearance became inferior in the second wear resistance test (traverse test), and the antifogging film surface had a sticky feeling.

### COMPARATIVE EXAMPLE 3

Example 4 was repeated except that the surfactant was omitted and the hydrophobic polyol was in an amount of 34 g in the preparation of the second coating agent and that 43.5 g of the first coating agent were mixed with 56.5 g of the second coating agent. The total weight of the urethane components was 100 g. The obtained antifogging film was 31 μm in thickness.

### COMPARATIVE EXAMPLE 4

Example 4 was repeated except that the water-absorbing polyol was omitted and the hydrophobic polyol was in an amount of 39.5 g in the preparation of the second coating agent and that 43 g of the first coating agent were mixed with 57 g of the second coating agent. The obtained antifogging film was 31 μm in thickness.

### COMPARATIVE EXAMPLE 5

Example 4 was repeated except that the short chain polyol was omitted, a polycaprolactone diol (average molecular weight: 500) in an amount of 24.9 g was used as the hydrophobic polyol, and the amounts of the surfactant and the water-absorbing polyol were respectively changed to 24.9 g and 20 g in the preparation of the second coating agent, that 37.6 g of the first coating agent were mixed with 69.8 g of the second coating agent to prepare a coating agent, and that a polyether-modified silicone (“L-7607N” made by Nippon Unicar Co., Ltd.) was added in place of the short chain polyol to the coating agent such that the coating agent contained 0.05 wt % of the polyether-modified silicone. The obtained antifogging film was 31 μm in thickness.

### COMPARATIVE EXAMPLE 6

Example 4 was repeated except that (a) 137.5 g of ethyl silicate (as a metal oxide precursor of the present invention), (b) 12.5 g of 3-methacryloxypropyltrimethoxysilane (as a silane coupling agent of the present invention), and (c) 1 g of 0.1N nitric acid were additionally added to the second coating agent of Example 4. The obtained antifogging film was 19 μm in thickness.

The entire contents of Japanese patent application nos. 2002-224385 (filed Aug. 1, 2002), 2002-229446 (filed Aug. 7, 2002), 2002-278888 (filed Sep. 25, 2002), 2003-144857 (filed May 22, 2003), 2003-173053 (filed Jun. 18, 2003), and 2003-272270 (filed Jul. 9, 2003), which are basic Japanese applications of the present application, are incorporated herein by reference.

1. A two-package coating agent for forming an antifogging film, the coating agent comprising:
a first coating agent comprising an isocyanate component containing an isocyanate group; and
a second coating agent comprising (a) a polyol component comprising at least a water-absorbing polyol and a hydrophobic polyol and (b) a surfactant containing a group that is reactive with the isocyanate group.

2. A coating agent according to claim 1, wherein the surfactant, the water-absorbing polyol, and the hydrophobic polyol are respectively in amounts of 10-25 wt %, 10-25 wt %, and 2.5-40 wt %, based on a total weight of the isocyanate component, the polyol component, and the surfactant.

3. A coating agent according to claim 1, wherein the polyol component further comprises a short chain polyol having an average molecular weight of from 60 to 200.

4. A coating agent according to claim 3, wherein the short chain polyol is in an amount of 2.5-10 wt %, based on the total weight of the isocyanate component, the polyol component, and the surfactant.

5. A coating agent according to claim 1, wherein the water-absorbing polyol is a polyoxyalkylene.

6. A coating agent according to claim 5, wherein the polyoxyalkylene is a polyethylene glycol having an average molecular weight of from 400 to 2,000.

7. A coating agent according to claim 5, wherein the polyoxyalkylene is a mixture of (a) a polyethylene glycol having an average molecular weight of from 400 to 2,000 and (b) a polyol that is a copolymer of oxyethylene and oxypropylene and that has an average molecular weight of from 1,500 to 5,000.

8. A coating agent according to claim 1, wherein the hydrophobic polyol is a polyester polyol having an average molecular weight of from 500 to 2,000.

9. A coating agent according to claim 8, wherein the polyester polyol is selected from the group consisting of polycarbonate polyols, polycaprolactone polyols, and mixtures of these.

10. A coating agent according to claim 1, wherein the second coating agent further comprises a silane coupling agent comprising a group that is reactive with the isocyanate group of the isocyanate component.

11. A coating agent according to claim 1, wherein the second coating agent further comprises a precursor of a metal oxide.

12. A coating agent according to claim 11, wherein a weight ratio of the precursor of the metal oxide to a total of the isocyanate component, the polyol component and the surfactant is 1.25 or less.

13. A coating agent according to claim 1, wherein at least one of the first and second coating agents further comprises metal oxide particles having an average particle size of from 5 nm to 50 nm.

14. A coating agent according to claim 3, wherein the short chain polyol contains two or three hydroxyl groups in the molecule.

15. A coating agent according to claim 10, wherein the silane coupling agent is 3-methacryloxypropyltrimethoxysilane or 3-glycidoxypropyltrimethoxysilane.

16. An antifogging article comprising:
a substrate; and
an antifogging, urethane resin film formed on the substrate, the urethane resin film comprising (a) a hydrophobic component derived from a hydrophobic polyol, (b) a water-absorbing component derived from a water-absorbing polyol, and (c) a surfactant bonded to a urethane resin crosslinked structure of the urethane resin film.

17. A method for forming an antifogging film on a substrate, the method comprising the steps of:
(a) providing a first coating agent comprising an isocyanate containing an isocyanate group;
(b) providing a second coating agent comprising (1) a polyol component comprising at least a water-absorbing polyol and a hydrophobic polyol and (2) a surfactant containing a group that is reactive with the isocyanate group;
(c) mixing the first and second coating agents together to prepare a coating agent;
(d) applying the coating agent to the substrate to form a precursory film on the substrate; and
(e) hardening the precursory film under room temperature or heating into the antifogging film.
